(19) United States
(12) Patent Application Publication
(10) Pub. No.: US 2026/0092011 A1
(43) Pub. Date: Apr. 2, 2026

(54) HIGH-TOUGHNESS MAGNESIUM-CALCIUM BINDER MORTAR MATERIAL FROM MULTI-COMPONENT HIGH-SALINITY SOLID WASTE AND PREPARATION METHOD THEREOF

(71) Applicant: Changjiang River Scientific Research Institute, Wuhan City (CN)

(72) Inventors: Xian ZHOU, Wuhan City (CN); Xia CHEN, Wuhan City (CN); Jiazheng LI, Wuhan City (CN); Wei HAN, Wuhan City (CN); Zeyu FAN, Wuhan City (CN); Zedong QIU, Wuhan City (CN); Chao GUO, Wuhan City (CN); Qi LU, Wuhan City (CN); Yinjun ZHOU, Wuhan City (CN); Xingdong LYU, Wuhan City (CN); Yuanyi WANG, Wuhan City (CN); Jinwei QIU, Wuhan City (CN); Tongchuan CHE, Wuhan City (CN); Jirong LAN, Wuhan City (CN); Ke MENG, Wuhan City (CN); Yongquan WANG, Wuhan City (CN); Hao RONG, Wuhan City (CN); Shanshan DENG, Wuhan City (CN); Fangmao GAN, Wuhan City (CN); Xiao LI, Wuhan City (CN); Sheng YOU, Wuhan City (CN); Shaohui LYU, Wuhan City (CN)

(21) Appl. No.: 19/297,008

(22) Filed: Aug. 12, 2025

(30) Foreign Application Priority Data
Sep. 28, 2024 (CN) 202411363988.8

(51) Int. Cl. C04B 28/14; C04B 14/06; C04B 14/26; C04B 14/38; C04B 16/06; C04B 18/08; C04B 18/22; C04B 22/16; C04B 24/12; C04B 24/26; C04B 40/00; C04B 103/30; C04B 103/56; C04B 111/00

(52) U.S. Cl. CPC C04B 28/142; C04B 14/06; C04B 14/26; C04B 14/386; C04B 16/0641; C04B 18/08; C04B 18/22; C04B 22/165; C04B 24/122; C04B 24/2641; C04B 40/0046; C04B 2103/302; C04B 2103/58; C04B 2111/00784

(57) ABSTRACT

A high-toughness magnesium-calcium binder mortar material from multi-component high-salinity solid waste and a preparation method thereof are provided. Raw materials of the high-toughness magnesium-calcium binder mortar material from multi-component high-salinity solid waste include a dry powder mortar material, a shrinkage reducing agent, a water reducing agent and fibers, where an addition amount of the fibers is 1.0-2.0% of a mass of the dry powder mortar material; where in parts by weight, the dry powder mortar material includes: 28-40 parts of aging mixture, 10-15 parts of industrial solid waste gypsum, 5-8 parts of light burned magnesium oxide, 2-5 parts of high alumina cement, 3-8 parts of rubber powder and 30-40 parts of artificial fine sand; and where in parts by weight, the aging mixture includes 50-70 parts of municipal solid waste incineration (MSWI) fly ash and 30-50 parts of magnesite, as well as aluminum dihydrogen phosphate solution and phosphogypsum leachate.

### CROSS-REFERENCE TO RELATED APPLICATIONS

This application claims priority to Chinese Patent Application No. 202411363988.8, filed on Sep. 28, 2024, the contents of which are hereby incorporated by reference.

### TECHNICAL FIELD

The disclosure belongs to the technical field of harmless and recycling of solid wastes, and in particular to a high-toughness magnesium-calcium binder mortar material from multi-component high-salinity solid waste and a preparation method thereof.

### BACKGROUND

At present, there are three main approaches for treating municipal solid waste incineration (MSWI) fly ash: solidification followed by disposal in hazardous waste landfills, stabilization followed by sanitary landfilling and resource recovery and recycling. Common solidification and stabilization techniques include cement solidification, melt solidification, and chelation stabilization. After stabilization, the MSWI fly ash is disposed of in landfills. Most hazardous waste treatment facilities charge over 1000 RMB per ton for MSWI fly ash disposal, with fees reaching as high as 3000 RMB/ton in regions with limited disposal capacity. Even when pretreated to meet strict standards for sanitary landfilling, the cost remains high at 500-1000 RMB/ton, increasing overall waste treatment expenses by 80-300 RMB/ton. As a result, developing MSWI fly ash recycling technologies and reducing landfill costs have become key research focuses and the dominant trend in MSWI fly ash management. However, due to differences in production processes, grate furnace MSWI fly ash typically contains less than 2% SiO₂ and Al₂O₃, along with high levels of soluble salts (e.g., NaCl, KCl, and CaClOH). These properties severely limit its usability as a supplementary cementitious material in conventional Portland cement or geopolymer systems.

On the other hand, phosphogypsum consists primarily of calcium sulfate but contains impurities such as P, F, and free acids. Long-term stockpiling may lead to soil and groundwater contamination, posing significant environmental risks while also representing a major waste of resources. The management and utilization of phosphogypsum remain a global challenge. The average utilization rate of phosphogypsum in the world is only 4.5%, and the utilization efficiency and economic value are low.

The patent with the application publication number CN106377867A discloses a heavy metal solidification agent for solid waste incineration fly ash and a solidification method thereof. The solidification agent consists of alumina- and silica-rich materials and an alkaline activator, leveraging the abundant calcium oxide, chlorides, and sulfides in solid waste incineration fly ash to trigger hydration reaction. The reaction generates calcium silicate hydrate (C—S—H), calcium chloroaluminate (Friedel's salt) and ettringite (AFt) phase systems.

However, aluminosilicate is the main component of the above technology. At present, grate furnace incineration technology is the main technology in domestic incinerators, and the content of silicon and aluminum in MSWI fly ash produced by grate furnace is extremely low. If the above technology is used, a large number of alumina- and silica-rich materials still need to be added, and the stabilizing effect of this technology on a large number of soluble chloride salts in MSWI fly ash is limited.

### SUMMARY

Aiming at the problems of difficulty in recycling municipal solid waste incineration (MSWI) fly ash and low utilization rate of phosphogypsum in the prior art, the disclosure provides a high-toughness magnesium-calcium binder mortar material from multi-component high-salinity solid waste and a preparation method thereof. In the method, soluble chloride in MSWI fly ash and sulfate in phosphogypsum are directly utilized to start a reaction under acidic conditions without pretreatment such as washing MSWI fly ash with water and adjusting pH value of phosphogypsum. Multi-phase magnesium-calcium binder system including 3Mg(OH)₂·MgCl₂·8H₂O, 5Mg(OH)₂·MgSO₄·7H₂O, MgKPO₄·6H₂O and Cas[Al(OH)₆]₂Cl₂·6H₂O are produced by adjusting the proportion of raw materials, which makes the obtained mortar materials have good mechanical properties and are used for solidification and stabilizing heavy metals such as Pb, Zn, Cd and As.

In order to achieve the above purpose, the disclosure provides a high-toughness magnesium-calcium binder mortar material from multi-component high-salinity solid waste, where raw materials include a dry powder mortar material, a shrinkage reducing agent, a water reducing agent and fibers, where an addition amount of the fibers is 1.0-2.0% of a mass of the dry powder mortar material;
where in parts by weight, the dry powder mortar material includes: 28-40 parts of aging mixture, 10-15 parts of industrial solid waste gypsum, 5-8 parts of light burned magnesium oxide, 2-5 parts of high alumina cement, 3-8 parts of rubber powder and 30-40 parts of artificial fine sand; and
where in parts by weight, the aging mixture includes 50-70 parts of MSWI fly ash and 30-50 parts of magnesite, as well as aluminum dihydrogen phosphate solution and phosphogypsum leachate.

In an embodiment, the MSWI fly ash is grate furnace MSWI fly ash with a potassium content ≥4 weight percent (wt %) and a silicon content ≤3 wt %.

In an embodiment, a total addition amount of the aluminum dihydrogen phosphate solution and the phosphogypsum leachate is 80-100% of a total mass of the MSWI fly ash and the magnesite.

In an embodiment, the water reducing agent is a polycarboxylic acid high-performance water reducing agent, the water reducing rate is not less than 25%, and the addition amount is 0.4-1.2% of the mass of the dry powder mortar material.

In an embodiment, the shrinkage reducing agent is an amino alcohol shrinkage reducing agent, and the shrinkage reducing rate exceeds 20% in 28 days (d), and the addition amount is 0.5-1.5% of the mass of the dry powder mortar material.

In an embodiment, the fiber is one or more of polyethylene fiber, polyvinyl alcohol fiber and waste carbon fiber.

In an embodiment, the single length of the polyethylene fiber and the polyvinyl alcohol fiber is 10-50 millimeters (mm), and the diameter is 10-50 micrometers (μm). The waste carbon fiber is waste fiber such as airplane or wind turbine blade, which is heat-treated in N₂ atmosphere at 400-500 degrees Celsius (° C.) for 30 minutes (min), then cooled to room temperature and crushed to a length of 10-50 mm.

In an embodiment, specific surface area of the industrial solid waste gypsum is not less than 500 square meters per kilogram (m²/kg), which is obtained by mixing phosphogypsum or flue gas desulfurization gypsum in any proportion, drying and grinding.

In an embodiment, the high alumina cement is CA-80 aluminate cement meeting the technical requirements of GBT201-2015, and its specific surface area is not less than 300 m²/kg.

In an embodiment, the light burned magnesium oxide is obtained by calcining the magnesite at 950-1050° C., and a MgO content is not less than 90%.

In an embodiment, the rubber powder is vulcanized rubber powder, which conforms to GB/T 19208-2020.

In an embodiment, a maximum particle size of the artificial fine sand does not exceed 325 μm, and the apparent density is not less than 2700 m²/kg.

The disclosure also provides a preparation method of the high-toughness magnesium-calcium binder mortar material from multi-component high-salinity solid waste, including following steps:
mixing the MSWI fly ash and the magnesite, ball milling to obtain a solid waste mixture, mixing the aluminum dihydrogen phosphate solution and the phosphogypsum leachate to prepare a mixed solution, adding the mixed solution into the solid waste mixture, uniformly mixing, aging, drying, finely grinding and sieving to obtain the aging mixture;
adding the industrial solid waste gypsum, the light burned magnesium oxide, the high alumina cement, the rubber powder and the artificial fine sand into the aging mixture for dry powder mixing to obtain the dry powder mortar materials; and
adding water, the shrinkage reducing agent and the water reducing agent into the dry powder mortar material, uniformly stirring, adding the fiber, continuously stirring, pouring the mixed mortar material into a mold, and carrying out compact molding to obtain the high-toughness magnesium-calcium binder mortar material from multi-component high-salinity solid waste.

In an embodiment, the aluminum dihydrogen phosphate, the phosphogypsum leachate and the water are mixed, and pH is adjusted to 2.0-2.5 with phosphoric acid to obtain the mixed solution.

In an embodiment, a mixing time of the dry powder mixing is 30 seconds(s) and a rotating speed is 150 revolutions per minute (r/min).

In an embodiment, the aging time is 24 hours (h) and the drying temperature is 60° C.

In an embodiment, the fibers are added in twice, and a mass ratio of the fibers added twice is 1:1.

In an embodiment, the water-binder ratio of the high-toughness magnesium-calcium binder mortar material from multi-component high-salinity solid waste is 0.4-0.5, and the formed blocks need to be cured under standard conditions, which are usually 90%+5% relative humidity and 20° C.±5° C. temperature for 28 d to obtain the best performance.

Compared with the prior art, the disclosure has the following advantages and technical effects.

In the disclosure, MSWI fly ash and magnesite are mixed and ground, then acidic phosphoaluminate solution is added for aging, then industrial solid waste gypsum, light burned magnesium oxide, high alumina cement, rubber powder, artificial fine sand and the like are added to prepare dry powder mortar materials, and finally water is added for molding, so that the solid waste-based magnesium-calcium binder stabilized mortar materials are obtained. The high-toughness magnesium-calcium binder mortar material provided by the disclosure may start the reaction under acidic conditions, and at the same time, the MSWI fly ash, phosphogypsum and phosphogypsum leachate are utilized to generate multi-phase magnesium-calcium binder systems, thus creatively solving the resource utilization problem of high-salinity solid waste.

The high-toughness magnesium-calcium binder mortar material prepared by the disclosure realizes the coordinated development of quick hardening, high strength and high toughness, the compressive strength exceeds 15 megapascals (MPa) in 1 d, 40 MPa in 28 d, and the ultimate strain capacity reaches 2.8-3.7%, which breaks through the technical bottleneck of low toughness of conventional magnesium oxychloride cement and magnesium oxysulfide cement and is very suitable for dry and cold environments.

The high-toughness magnesium-calcium binder mortar material prepared by the disclosure is characterized in that the hydration products of magnesium potassium phosphate and calcium chloroaluminate hydrate have very good solidification effect on amphoteric and anionic heavy metals in MSWI fly ash, which breaks through the technical bottleneck of low solidification efficiency and poor durability of conventional Portland cement and chelating agent, significantly reduces the environmental risk in the material utilization process, and is safe and environment-friendly.

### BRIEF DESCRIPTION OF THE DRAWINGS

The attached drawings, which constitute a part of this disclosure, are used to provide a further understanding of this disclosure. The illustrative embodiments of this disclosure and their descriptions are used to explain this disclosure, and do not constitute an improper limitation of this disclosure. In the attached drawings:

FIG. 1 is a flow chart of a preparation method of the high-toughness magnesium-calcium binder mortar material from multi-component high-salinity solid waste.

FIG. 2 is a schematic diagram of the mechanism of hydration and heavy metal solidification of high-toughness magnesium-calcium binder mortar material from multi-component high-salinity solid waste.

FIG. 3 shows the compressive strength of mortar materials in Embodiments 1 to 15 and Comparative Embodiments 1 to 5 at different ages.

FIG. 4 shows the flexural strength of mortar materials in Embodiments 1 to 15 and Comparative Embodiments 1 to 5 at different ages.

FIG. 5 is an X-ray diffraction pattern of mortar materials in Embodiments 1 and 3.

FIG. 6A, FIG. 6B, FIG. 6C, FIG. 6D and FIG. 6E are scanning electron microscope (SEM) images of the aging products after step S1 in Embodiment 1.

FIG. 6A is the microscopic morphology of the aging product after step S1 in Embodiment 1, which is magnified by 10000 times.

FIG. 6B is the area distribution pattern of element Ca analyzed by energy dispersive spectroscopy (EDS) of the SEM pattern.

FIG. 6C is the area distribution pattern of element C analyzed by EDS of the SEM pattern.

FIG. 6D is the area distribution pattern of element Mg analyzed by EDS of the SEM pattern.

FIG. 6E is the area distribution pattern of element Cl analyzed by EDS of the SEM pattern.

FIG. 7 shows the ultimate tensile strength of mortar materials in Embodiments 1 to 15 and Comparative Embodiments 1 to 5 after curing for 28 days (d).

FIG. 8 shows the ultimate tensile strain of mortar materials in Embodiments 1 to 15 and Comparative Embodiments 1 to 5 after curing for 28 d.

FIG. 9 shows the softening coefficient of mortar materials in Embodiments 1 to 15 and Comparative Embodiments 1 to 5 after curing for 28 d and soaking in water for 28 d.

### DETAILED DESCRIPTION OF THE EMBODIMENTS

A number of exemplary embodiments of the present disclosure will now be described in detail, and this detailed description should not be considered as a limitation of the present disclosure, but should be understood as a more detailed description of certain aspects, characteristics and embodiments of the present disclosure.

It should be understood that the terminology described in the present disclosure is only for describing specific embodiments and is not used to limit the present disclosure. In addition, for the numerical range in the present disclosure, it should be understood that each intermediate value between the upper limit and the lower limit of the range is also specifically disclosed. The intermediate value within any stated value or stated range and every smaller range between any other stated value or intermediate value within the stated range are also included in the present disclosure. The upper and lower limits of these smaller ranges may be independently included or excluded from the range.

Unless otherwise specified, all technical and scientific terms used herein have the same meaning as commonly understood by one of ordinary skill in the art to which this disclosure relates. Although the present disclosure only describes the optional methods and materials, any methods and materials similar or equivalent to those described herein may also be used in the practice or testing of the present disclosure. All documents mentioned in this specification are incorporated by reference to disclose and describe methods and/or materials related to the documents. In case of conflict with any incorporated document, the contents of this specification shall prevail.

It is obvious to those skilled in the art that many improvements and changes may be made to the specific embodiments of the present disclosure without departing from the scope or spirit of the present disclosure. Other embodiments will be apparent to the skilled person from the description of the disclosure. The description and example of that present disclosure are exemplary only.

The terms “comprising”, “including”, “having” and “containing” used in this article are all open terms, which means including but not limited to.

The embodiments of the disclosure provide a high-toughness magnesium-calcium binder mortar material from multi-component high-salinity solid waste, where raw materials include a dry powder mortar material, a shrinkage reducing agent, a water reducing agent and fibers, where an addition amount of the fibers is 1.0-2.0% of a mass of the dry powder mortar material;
where in parts by weight, the dry powder mortar material includes: 28-40 parts of aging mixture, 10-15 parts of industrial solid waste gypsum, 5-8 parts of light burned magnesium oxide, 2-5 parts of high alumina cement, 3-8 parts of rubber powder and 30-40 parts of artificial fine sand; and
where in parts by weight, the aging mixture includes 50-70 parts of municipal solid waste incineration (MSWI) fly ash and 30-50 parts of magnesite, as well as aluminum dihydrogen phosphate solution and phosphogypsum leachate.

In an optional embodiment of the disclosure, the MSWI fly ash is grate furnace MSWI fly ash with a potassium content ≥4 weight percent (wt %) and a silicon content ≤3 wt %.

More specifically, the MSWI fly ash used in the embodiments of the disclosure is solid waste incineration fly ash, which comes from Yichang MSWI power plant, and the magnesite used is purchased from Liaoning Haicheng Oriental Sliding Magnesium Company.

In an optional embodiment of the present disclosure, a total addition amount of the aluminum dihydrogen phosphate solution and the phosphogypsum leachate is 80-100% of a total mass of the MSWI fly ash and the magnesite. Taking 1000 grams (g) MSWI fly ash and magnesite as examples, the addition amount of aluminum dihydrogen phosphate solution and phosphogypsum leachate is 800-1000 milliliters (mL).

In an optional embodiment of the disclosure, the water reducing agent is a polycarboxylic acid high-performance water reducing agent, the water reducing rate is not less than 25%, and the addition amount is 0.4-1.2% of the mass of the dry powder mortar material.

More specifically, the purchasing source of polycarboxylic acid high-performance water reducing agent used in the embodiments of the disclosure is Jiangsu Subote New Materials Co., Ltd.

In an optional embodiment of the disclosure, the shrinkage reducing agent is an amino alcohol shrinkage reducing agent, and the shrinkage reducing rate exceeds 20% in 28 days (d), and the addition amount is 0.5-1.5% of the mass of the dry powder mortar material.

More specifically, the purchasing source of the amino alcohol shrinkage reducing agent used in the embodiments of the disclosure is Jiangsu Subote New Materials Co., Ltd.

In an optional embodiment of the present disclosure, the fiber is one or more of polyethylene fiber, polyvinyl alcohol fiber and waste carbon fiber.

In an optional embodiment of the disclosure, the single length of the polyethylene fiber and the polyvinyl alcohol fiber is 10-50 millimeters (mm), and the diameter is 10-50 micrometers (μm). The waste carbon fiber is waste fiber such as airplane or wind turbine blade, which is heat-treated in N₂ atmosphere at 400-500 degrees Celsius (C) for 30 minutes (min), then cooled to room temperature and crushed to a length of 10-50 mm.

More specifically, the purchasing source of the polyethylene fiber used in the embodiments of the disclosure is Shandong Yitai Engineering Materials Co., Ltd., the polyvinyl alcohol fiber is the polyvinyl alcohol fiber purchased from Shanghai Laiyuan Chemical Industry, and the source of the waste carbon fiber is the abandoned wing of an airplane made in China, which is heat-treated in N₂ atmosphere at 400° C. for 30 min, then cooled to room temperature and crushed to a length of 10-50 mm.

In an optional embodiment of the disclosure, specific surface area of the industrial solid waste gypsum is not less than 500 square meters per kilogram (m²/kg), which is obtained by mixing phosphogypsum or flue gas desulfurization gypsum in any proportion, drying and grinding.

More specifically, the source of phosphogypsum used in the embodiments of the disclosure is the yard of Hubei Xinyangfeng Fertilizer Co., Ltd., and the source of flue gas desulfurization gypsum is Yicheng Power Generation Co., Ltd.

In an optional embodiment of the disclosure, the high alumina cement is CA-80 aluminate cement meeting the technical requirements of GBT201-2015, and its specific surface area is not less than 300 m²/kg.

More specifically, the CA-80 aluminate cement that meets the technical requirements of GBT201-2015 used in the embodiments of the disclosure is purchased from Gezhouba Shimen Special Cement Co., Ltd.

In an optional embodiment of the disclosure, the light burned magnesium oxide is obtained by calcining the magnesite at 950-1050° C., and a MgO content is not less than 90%.

More specifically, the light burned magnesium oxide used in the embodiments of the disclosure is obtained by calcining magnesite at 950° C.

In an optional embodiment of the disclosure, the rubber powder is vulcanized rubber powder, which conforms to GB/T 19208-2020.

More specifically, the purchasing source of vulcanized rubber powder used in the embodiments of the disclosure is Hengshui Hongyun Special Recycled Rubber Co., Ltd.

In an optional embodiment of the disclosure, a maximum particle size of the artificial fine sand does not exceed 325 μm, and the apparent density is not less than 2700 m²/kg.

More specifically, the purchasing source of the artificial fine sand used in the embodiments of the disclosure is Wuhan Filtration Water Purification Material Co., Ltd.

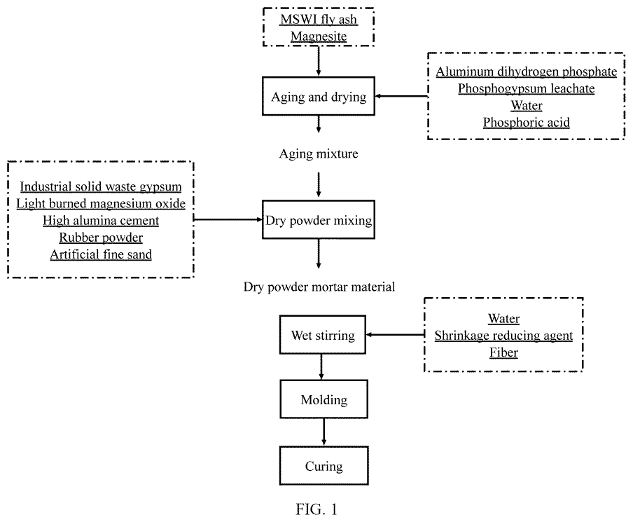

The embodiments of the disclosure also provide a preparation method of the high-toughness magnesium-calcium binder mortar material from multi-component high-salinity solid waste, and the flow chart is shown in FIG. 1, which specifically includes the following steps:
mixing the MSWI fly ash and the magnesite, ball milling to obtain a solid waste mixture, mixing the aluminum dihydrogen phosphate solution and the phosphogypsum leachate to prepare a mixed solution, adding the mixed solution into the solid waste mixture, uniformly mixing, aging, drying, finely grinding and sieving to obtain the aging mixture;
adding the industrial solid waste gypsum, the light burned magnesium oxide, the high alumina cement, the rubber powder and the artificial fine sand into the aging mixture for dry powder mixing to obtain the dry powder mortar materials; and
adding water, the shrinkage reducing agent and the water reducing agent into the dry powder mortar material, uniformly stirring, adding the fiber, continuously stirring, pouring the mixed mortar material into a mold, and carrying out compact molding to obtain the high-toughness magnesium-calcium binder mortar material from multi-component high-salinity solid waste.

In an optional embodiment of the present disclosure, the aluminum dihydrogen phosphate, the phosphogypsum leachate and the water are mixed, and pH is adjusted to 2.0-2.5 with phosphoric acid to obtain the mixed solution.

In an optional embodiment of the present disclosure, a mixing time of the dry powder mixing is 30 seconds(s) and a rotating speed is 150 revolutions per minute (r/min).

In an optional embodiment of the present disclosure, the aging time is 24 hours (h) and the drying temperature is 60° C.

In an optional embodiment of the disclosure, the fibers are added in twice, and a mass ratio of the fibers added twice is 1:1.

In an optional embodiment of the disclosure, the water-binder ratio of the high-toughness magnesium-calcium binder mortar material from multi-component high-salinity solid waste is 0.4-0.5, and the formed blocks need to be cured under standard conditions, which are usually 90%+5% relative humidity and 20° C.±5° C. temperature for 28 d to obtain the best performance.

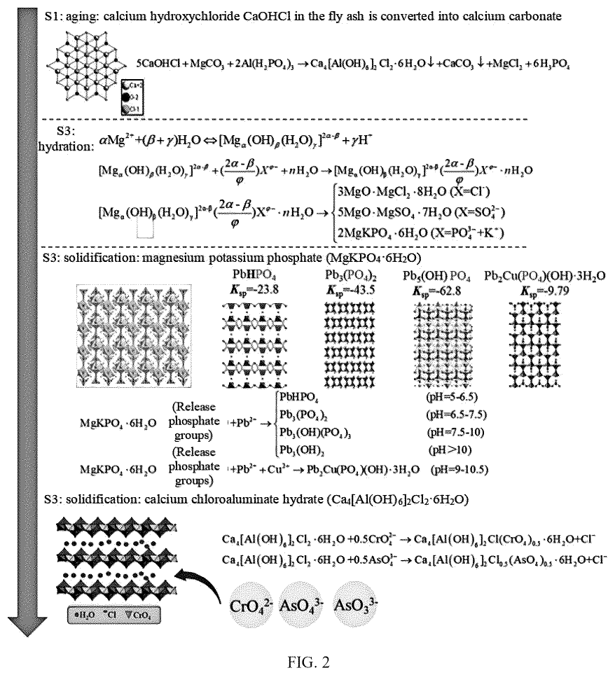

The schematic diagram of the mechanism of hydration and heavy metal solidification of the high-toughness magnesium-calcium binder mortar material from multi-component high-salinity solid waste of the present disclosure is shown in FIG. 2, specifically:

According to the preparation method of the high-toughness magnesium-calcium binder mortar material from multi-component high-salinity solid waste, during aging, most magnesium sources are magnesite, and calcination is not needed. Magnesium carbonate (solubility product constant Ksp=−7.46) in magnesite is converted into soluble magnesium salt with high activity by using acid phosphogypsum leachate and aluminum dihydrogen phosphate, and part of calcium hydroxychloride in MSWI fly ash is converted into calcium carbonate (solubility product constant Ksp=−8.48) and calcium chloroaluminate hydrate Ca₄[Al(OH)₆]₂Cl₂·6H₂O (solubility product constant Ksp=−28.28), thereby reducing the content of soluble chloride salts. The reaction equations for this process are as follows:

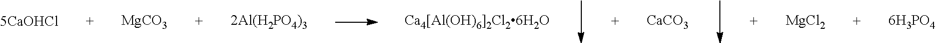

Calcium carbonate and calcium chloroaluminate hydrate produced during aging may be used as inert fillers to fill the pores of magnesium-calcium binder mortar materials and produce soluble magnesium salts with high activity. In addition, when aging and drying, it may capture CO₂ in the air and promote the production of calcium carbonate.

In the process of mortar hydration, the soluble magnesium salt in the aging mixture is used to hydrate to generate polyhydroxy magnesium ions [Mg_{α}(OH)_{β}(H₂O)_{γ}]^{2α-β}, and under the action of chloride salt and potassium salt in MSWI fly ash, sulfate ion in industrial solid waste gypsum and high alumina cement, and phosphate ion in the aging mixture, the polymerization reaction produces 3MgO·MgCl₂·8H₂O, 5MgO·MgSO₄·7H₂O and 2MgKPO₄·6H₂O multi-phase magnesium-calcium binder systems. The reaction equation of this process is as follows:

$$α {Mg}^{2 +} + ( β + γ ) {H}_{2} O ⇔ {[ {{Mg}_{α} ( OH )}_{β} {( {H}_{2} O )}_{γ} ]}^{2 α - β} + γ {H}^{+}$$

$${[ {{Mg}_{α} ( OH )}_{β} {( {H}_{2} O )}_{γ} ]}^{2 α - β} + ( \frac{2 α - β}{φ} ) {X}^{φ -} + n {H}_{2} O \to {[ {{Mg}_{α} ( OH )}_{β} {( {H}_{2} O )}_{γ} ]}^{2 α - β} ( \frac{2 α - β}{φ} ) {X}^{φ -} \cdot n {H}_{2} O$$

$${[ {{Mg}_{α} ( OH )}_{β} {( {H}_{2} O )}_{γ} ]}^{2 α - β} ( \frac{2 α - β}{φ} ) {X}^{φ -} \cdot n {H}_{2} O \to \{ \begin{matrix}3 MgO \cdot {MgCl}_{2} \cdot 8 {H}_{2} O ( X = {Cl}^{-} ) \\ 5 MgO \cdot {MgSO}_{4} \cdot 7 {H}_{2} O ( X = {SO}_{4}^{2 -} ) \\ 2 {MgKPO}_{4} \cdot 6 {H}_{2} O ( X = {PO}_{4}^{3 -} + {K}^{+} )\end{matrix}$$

The high-toughness magnesium-calcium binder mortar material prepared by the disclosure forms a compact packing structure by optimizing the gradation of multi-component powder materials; the light burned magnesium oxide and shrinkage reducing agent are adopted to reduce the volume shrinkage deformation caused by the hydration of magnesium-calcium binder stable products; the fibers play a toughening role and improve the crack resistance of the mortar material; the introduction of phosphogypsum and phosphate groups in its leachate may significantly improve the water stability of 3MgO·MgCl₂·8H₂O and 5MgO·MgSO₄·7H₂O, and the water resistance of the magnesium-calcium binder mortar material; Moreover, the active aluminum component in high alumina cement further consumes free calcium ions and chloride ions to produce calcium chloroaluminate hydrate Ca₄[Al(OH)₆]₂Cl₂·6H₂O.

The high-toughness magnesium-calcium binder mortar material prepared by the disclosure, magnesium potassium phosphate and calcium chloroaluminate hydrate have very good solidification effect on amphoteric and anionic heavy metals in MSWI fly ash; Among them, magnesium potassium phosphate may solidify Pb, Cu, Zn, Cd and other heavy metals in weak acid environment, and even realize the synergistic solidification of Pb and Cu. Calcium chloroaluminate hydrate has excellent solidification effect on oxygen-containing anion groups of heavy metals such as CrO₄²⁻ and AsO₄³⁻. The reaction equation of this process is as follows:

$${MgKPO}_{4} \cdot 6 {H}_{2} O ( release phosphate groups ) + {Pb}^{2 +} \to \{ \begin{matrix}{PbHPO}_{4} & ( pH = 5 - 6.5 ) \\ {{Pb}_{3} ( {PO}_{4} )}_{2} & ( pH = 6.5 - 7.5 ) \\ {Pb}_{3} ( OH ) {( {PO}_{4} )}_{3} & ( pH = 7.5 - 10 ) \\ {{Pb}_{3} ( OH )}_{2} & ( pH > 10 )\end{matrix}$$

$${MgKPO}_{4} \cdot 6 {H}_{2} O ( release phosphate groups ) + {Pb}^{2 +} + {Cu}^{2 +} \to {Pb}_{2} CU ( {PO}_{4} ) ( OH ) \cdot 3 {H}_{2} O ( pH = 9 - 10.5 )$$

$${{Ca}_{4} [ {Al ( OH )}_{6} ]}_{2} {Cl}_{2} \cdot 6 {H}_{2} O + {CrO}_{4}^{2 -} \to {{Ca}_{4} [ {Al ( OH )}_{6} ]}_{2} {CrO}_{4} \cdot 6 {H}_{2} O + 2 {Cl}^{-}$$

$${{Ca}_{4} [ {Al ( OH )}_{6} ]}_{2} {Cl}_{2} \cdot 6 {H}_{2} O + {AsO}_{4}^{3 -} \to {{Ca}_{4} [ {Al ( OH )}_{6} ]}_{2} {AsO}_{4} \cdot 6 {H}_{2} O + 2 {Cl}^{-}$$

The technical schemes of the present disclosure will be further explained by embodiments.

### Embodiment 1

S1. 700 g of MSWI fly ash and 300 g of magnesite are mixed and ball-milled to obtain a solid waste mixture; 1000 mL of 10 grams per liter (g/L) aluminum dihydrogen phosphate aqueous solution and 1000 mL of 10 g/L phosphogypsum leachate are mixed to prepare a mixed solution; the pH of the mixed solution is adjusted to 2.5 with phosphoric acid; 1000 mL of the mixed solution is added into the solid waste mixture to be evenly mixed, aging for 24 h, dried at 60° C., and finely ground and sieved to obtain an aging mixture.

S2. 400 g of the aging mixture obtained in the step S1 is taken. 150 g of phosphogypsum, 50 g of light burned magnesium oxide, 50 g of high alumina cement, 30 g of rubber powder and 320 g of artificial fine sand are added into the aging mixture. Dry powder mixing is performed under the condition of 150 r/min to obtain dry powder mortar materials. Among them, the specific surface area of phosphogypsum is more than or equal to 500 m²/kg, light burned magnesium oxide is type II magnesium oxide meeting DL/T5296-2014, high alumina cement is CA-80 aluminate cement meeting GBT201-2015 technical requirements, rubber powder is 200-mesh vulcanized rubber powder meeting GB/T19208-2020, the maximum particle size of artificial fine sand is not more than 325 μm, and the apparent density is not less than 2730 kilograms per cubic meter (kg/m³).

S3. 400 ml of water, 15 g of amino alcohol shrinkage reducing agent and 12 g of polycarboxylic acid high-performance water reducing agent are added to the prepared dry powder mortar material (1 kilogram (kg)). The mixture is stirred at a speed of 300 r/min. 20 g of waste carbon fibers with a single length of 46.3 mm is added, and it is added in twice. ½ of the total fiber amount is added for the first time. The mixture is continuously stirred for 30 s. The remaining fiber material is added. After stirring at the same speed for 90 s, the mortar material is obtained. The mixed mortar is poured into the mold, and the material is compacted by manual tamping and shaking table vibration, and the high-toughness magnesium-calcium binder mortar material from multi-component high-salinity solid waste may be obtained by curing to the corresponding age.

### Embodiment 2

It is the same as Embodiment 1, and the only difference is that in the step S1, the amount of mixed solution added to the solid waste mixture is 800 mL.

### Embodiment 3

It is the same as Embodiment 1, and the only difference is that in the step S1, 500 g of MSWI fly ash and 500 g of magnesite are contained in the solid waste mixture.

### Embodiment 4

It is the same as Embodiment 1, and the only difference is that in the step S1, when adjusting the pH, the pH of the mixed solution is adjusted to 2.0 with phosphoric acid.

### Embodiment 5

It is the same as Embodiment 1, and the only difference is that in the step S2, 150 g phosphogypsum is replaced by flue gas desulfurization gypsum.

### Embodiment 6

It is the same as Embodiment 1, and the only difference is that in the step S3, the waste carbon fiber is replaced by polyvinyl alcohol fiber with an average root length of 18 mm.

### Embodiment 7

It is the same as Embodiment 1, and the only difference is that in the step S3, 500 mL of water, 15 g of amino alcohol shrinkage reducing agent and 12 g of polycarboxylic acid high-performance water reducing agent are added to the prepared dry powder mortar material (1 kg).

### Embodiment 8

Step S1 is the same as in Embodiment 1.

S2. 300 g of the aging mixture obtained in the step S1 is taken. 100 g of phosphogypsum, 80 g of light burned magnesium oxide, 50 g of high alumina cement, 80 g of rubber powder and 390 g of artificial fine sand are added into the aging mixture for dry powder mixing to obtain dry powder mortar material. Among them, the specific surface area of phosphogypsum is more than or equal to 500 m²/kg, light burned magnesium oxide is type II magnesium oxide meeting DL/T5296-2014, high alumina cement is CA-80 aluminate cement meeting GBT201-2015 technical requirements, rubber powder is 200-mesh vulcanized rubber powder meeting GB/T19208-2020, the maximum particle size of artificial fine sand is not more than 325 μm, and the apparent density is not less than 2730 kg/m³.

S3. 400 mL of water, 15 g of amino alcohol shrinkage reducing agent and 4 g of polycarboxylic acid high-performance water reducing agent are added to the prepared dry powder mortar material (1 kg). The mixture is stirred at a speed of 300 r/min. 10 g of waste carbon fibers with a single length of 46.3 mm is added, and it is added in twice. ½ of the total fiber amount is added for the first time. The mixture is continuously stirred for 30 s. The remaining fiber material is added. After stirring at the same speed for 90 s, the mortar material is obtained. The mixed mortar is poured into the mold, and the material is compacted by manual tamping and shaking table vibration, and the high-toughness magnesium-calcium binder mortar material from multi-component high-salinity solid waste may be obtained by curing to the corresponding age.

### Embodiment 9

Step S1 is the same as in Embodiment 1.

S2. 350 g of the aging mixture obtained in the step S1 is taken. 120 g of phosphogypsum, 80 g of light burned magnesium oxide, 20 g of high alumina cement, 30 g of rubber powder and 400 g of artificial fine sand are added into the aging mixture for dry powder mixing to obtain dry powder mortar material. Among them, the specific surface area of phosphogypsum is more than or equal to 500 m²/kg, light burned magnesium oxide is type II magnesium oxide meeting DL/T5296-2014, high alumina cement is CA-80 aluminate cement meeting GBT201-2015 technical requirements, rubber powder is 200-mesh vulcanized rubber powder meeting GB/T19208-2020, the maximum particle size of artificial fine sand is not more than 325 μm, and the apparent density is not less than 2730 kg/m³.

S3. 400 mL of water, 5 g of amino alcohol shrinkage reducing agent and 12 g of polycarboxylic acid high-performance water reducing agent are added to the prepared dry powder mortar material (1 kg). The mixture is stirred at a speed of 300 r/min. 20 g of waste carbon fibers with a single length of 46.3 mm is added, and it is added in twice. ½ of the total fiber amount is added for the first time. The mixture is continuously stirred for 30 s. The remaining fiber material is added. After stirring at the same speed for 90 s, the mortar material is obtained. The mixed mortar is poured into the mold, and the material is compacted by manual tamping and shaking table vibration, and the high-toughness magnesium-calcium binder mortar material from multi-component high-salinity solid waste may be obtained by curing to the corresponding age.

### Embodiment 10

Step S1 is the same as in Embodiment 1.

S2. 290 g of the aging mixture obtained in the step S1 is taken. 150 g of phosphogypsum, 80 g of light burned magnesium oxide, 50 g of high alumina cement, 30 g of rubber powder and 400 g of artificial fine sand are added into the aging mixture for dry powder mixing to obtain dry powder mortar material. Among them, the specific surface area of phosphogypsum is more than or equal to 500 m²/kg, light burned magnesium oxide is type II magnesium oxide meeting DL/T5296-2014, high alumina cement is CA-80 aluminate cement meeting GBT201-2015 technical requirements, rubber powder is 200-mesh vulcanized rubber powder meeting GB/T19208-2020, the maximum particle size of artificial fine sand is not more than 325 μm, and the apparent density is not less than 2730 kg/m³.

S3. 400 mL of water, 15 g of amino alcohol shrinkage reducing agent and 4 g of polycarboxylic acid high-performance water reducing agent are added to the prepared dry powder mortar material (1 kg). The mixture is stirred at a speed of 300 r/min. 10 g of waste carbon fibers with a single length of 46.3 mm is added, and it is added in twice. ½ of the total fiber amount is added for the first time. The mixture is continuously stirred for 30 s. The remaining fiber material is added. After stirring at the same speed for 90 s, the mortar material is obtained. The mixed mortar is poured into the mold, and the material is compacted by manual tamping and shaking table vibration, and the high-toughness magnesium-calcium binder mortar material from multi-component high-salinity solid waste may be obtained by curing to the corresponding age.

### Embodiment 11

Step S1 is the same as in Embodiment 1, and the only difference is that the pH is adjusted to 2.0 with phosphoric acid.

S2. 350 g of the aging mixture obtained in the step S1 is taken. 100 g of phosphogypsum, 50 g of light burned magnesium oxide, 50 g of high alumina cement, 50 g of rubber powder and 400 g of artificial fine sand are added into the aging mixture for dry powder mixing to obtain dry powder mortar material. Among them, the specific surface area of phosphogypsum is more than or equal to 500 m²/kg, light burned magnesium oxide is type II magnesium oxide meeting DL/T5296-2014, high alumina cement is CA-80 aluminate cement meeting GBT201-2015 technical requirements, rubber powder is 200-mesh vulcanized rubber powder meeting GB/T19208-2020, the maximum particle size of artificial fine sand is not more than 325 μm, and the apparent density is not less than 2730 kg/m³.

S3. 400 mL of water, 5 g of amino alcohol shrinkage reducing agent and 4 g of polycarboxylic acid high-performance water reducing agent are added to the prepared dry powder mortar material (1 kg). The mixture is stirred at a speed of 300 r/min. 20 g of waste carbon fibers with a single length of 46.3 mm is added, and it is added in twice. ½ of the total fiber amount is added for the first time. The mixture is continuously stirred for 30 s. The remaining fiber material is added. After stirring at the same speed for 90 s, the mortar material is obtained. The mixed mortar is poured into the mold, and the material is compacted by manual tamping and shaking table vibration, and the high-toughness magnesium-calcium binder mortar material from multi-component high-salinity solid waste may be obtained by curing to the corresponding age.

### Embodiment 12

Step S1 is the same as in Embodiment 1, and the only difference is that the pH is adjusted to 2.0 with phosphoric acid.

S2. 370 g of the aging mixture obtained in the step S1 is taken. 120 g of phosphogypsum, 80 g of light burned magnesium oxide, 50 g of high alumina cement, 80 g of rubber powder and 300 g of artificial fine sand are added into the aging mixture for dry powder mixing to obtain dry powder mortar material. Among them, the specific surface area of phosphogypsum is more than or equal to 500 m²/kg, light burned magnesium oxide is type II magnesium oxide meeting DL/T5296-2014, high alumina cement is CA-80 aluminate cement meeting GBT201-2015 technical requirements, rubber powder is 200-mesh vulcanized rubber powder meeting GB/T19208-2020, the maximum particle size of artificial fine sand is not more than 325 μm, and the apparent density is not less than 2730 kg/m³.

S3. 400 mL of water, 5 g of amino alcohol shrinkage reducing agent and 12 g of polycarboxylic acid high-performance water reducing agent are added to the prepared dry powder mortar material (1 kg). The mixture is stirred at a speed of 300 r/min. 10 g of waste carbon fibers with a single length of 46.3 mm is added, and it is added in twice. ½ of the total fiber amount is added for the first time. The mixture is continuously stirred for 30 s. The remaining fiber material is added. After stirring at the same speed for 90 s, the mortar material is obtained. The mixed mortar is poured into the mold, and the material is compacted by manual tamping and shaking table vibration, and the high-toughness magnesium-calcium binder mortar material from multi-component high-salinity solid waste may be obtained by curing to the corresponding age.

### Embodiment 13

Step S1 is the same as in Embodiment 1, and the only difference is that the pH is adjusted to 2.0 with phosphoric acid.

S2. 350 g of the aging mixture obtained in the step S1 is taken. 150 g of phosphogypsum, 50 g of light burned magnesium oxide, 20 g of high alumina cement, 30 g of rubber powder and 300 g of artificial fine sand are added into the aging mixture for dry powder mixing to obtain dry powder mortar material. Among them, the specific surface area of phosphogypsum is more than or equal to 500 m²/kg, light burned magnesium oxide is type II magnesium oxide meeting DL/T5296-2014, high alumina cement is CA-80 aluminate cement meeting GBT201-2015 technical requirements, rubber powder is 200-mesh vulcanized rubber powder meeting GB/T19208-2020, the maximum particle size of artificial fine sand is not more than 325 μm, and the apparent density is not less than 2730 kg/m³.

S3. 400 mL of water, 15 g of amino alcohol shrinkage reducing agent and 12 g of polycarboxylic acid high-performance water reducing agent are added to the prepared dry powder mortar material (1 kg). The mixture is stirred at a speed of 300 r/min. 10 g of waste carbon fibers with a single length of 46.3 mm is added, and it is added in twice. ½ of the total fiber amount is added for the first time. The mixture is continuously stirred for 30 s. The remaining fiber material is added. After stirring at the same speed for 90 s, the mortar material is obtained. The mixed mortar is poured into the mold, and the material is compacted by manual tamping and shaking table vibration, and the high-toughness magnesium-calcium binder mortar material from multi-component high-salinity solid waste may be obtained by curing to the corresponding age.

### Embodiment 14

Step S1 is the same as in Embodiment 1, and the only difference is that the pH is adjusted to 2.0 with phosphoric acid.

S2. 370 g of the aging mixture obtained in the step S1 is taken. 100 g of phosphogypsum, 80 g of light burned magnesium oxide, 20 g of high alumina cement, 80 g of rubber powder and 350 g of artificial fine sand are added into the aging mixture for dry powder mixing to obtain dry powder mortar material. Among them, the specific surface area of phosphogypsum is more than or equal to 500 m²/kg, light burned magnesium oxide is type II magnesium oxide meeting DL/T5296-2014, high alumina cement is CA-80 aluminate cement meeting GBT201-2015 technical requirements, rubber powder is 200-mesh vulcanized rubber powder meeting GB/T19208-2020, the maximum particle size of artificial fine sand is not more than 325 μm, and the apparent density is not less than 2730 kg/m³.

S3. 400 mL of water, 15 g of amino alcohol shrinkage reducing agent and 4 g of polycarboxylic acid high-performance water reducing agent are added to the prepared dry powder mortar material (1 kg). The mixture is stirred at a speed of 300 r/min. 20 g of waste carbon fibers with a single length of 46.3 mm is added, and it is added in twice. ½ of the total fiber amount is added for the first time. The mixture is continuously stirred for 30 s. The remaining fiber material is added. After stirring at the same speed for 90 s, the mortar material is obtained. The mixed mortar is poured into the mold, and the material is compacted by manual tamping and shaking table vibration, and the high-toughness magnesium-calcium binder mortar material from multi-component high-salinity solid waste may be obtained by curing to the corresponding age.

### Embodiment 15

Step S1 is the same as in Embodiment 1.

S2. 400 g of the aging mixture obtained in the step S1 is taken. 150 g of phosphogypsum, 50 g of light burned magnesium oxide, 20 g of high alumina cement, 30 g of rubber powder and 350 g of artificial fine sand are added into the aging mixture for dry powder mixing to obtain dry powder mortar material. Among them, the specific surface area of phosphogypsum is more than or equal to 500 m²/kg, light burned magnesium oxide is type II magnesium oxide meeting DL/T5296-2014, high alumina cement is CA-80 aluminate cement meeting GBT201-2015 technical requirements, rubber powder is 200-mesh vulcanized rubber powder meeting GB/T19208-2020, the maximum particle size of artificial fine sand is not more than 325 μm, and the apparent density is not less than 2730 kg/m³.

S3. 400 mL of water, 5 g of amino alcohol shrinkage reducing agent and 4 g of polycarboxylic acid high-performance water reducing agent are added to the prepared dry powder mortar material (1 kg). The mixture is stirred at a speed of 300 r/min. 10 g of waste carbon fibers with a single length of 46.3 mm is added, and it is added in twice. ½ of the total fiber amount is added for the first time. The mixture is continuously stirred for 30 s. The remaining fiber material is added. After stirring at the same speed for 90 s, the mortar material is obtained. The mixed mortar is poured into the mold, and the material is compacted by manual tamping and shaking table vibration, and the high-toughness magnesium-calcium binder mortar material from multi-component high-salinity solid waste may be obtained by curing to the corresponding age.

### Comparative Embodiment 1

It is the same as Embodiment 1, and the only difference is that magnesite is not added. In the step S1, 1000 g of MSWI fly ash is taken, 1000 mL of 10 g/L aluminum dihydrogen phosphate aqueous solution and 1000 mL of 10 g/L phosphogypsum leachate are mixed to prepare a mixed solution, the pH is adjusted to 2.5 with phosphoric acid, and 1000 mL of the mixed solution is added into the MSWI fly ash, mixed evenly, aging for 24 h, dried at 60° C., finely ground and screened to obtain the aging mixture.

### Comparative Embodiment 2

It is the same as Embodiment 1, and the only difference is that in the step S1, 700 g of MSWI fly ash and 300 g of magnesite are mixed and ball-milled to obtain a solid waste mixture, and 1000 mL of deionized water is added to the solid waste mixture to mix evenly, aging for 24 h, dried at 60° C., finely ground and sieved to obtain an aging mixture.

### Comparative Embodiment 3

It is the same as Embodiment 1, and the only difference is that in step S2, 550 g of aging mixture obtained in the step S1 is taken, 50 g of light burned magnesium oxide, 50 g of high alumina cement, 30 g of rubber powder and 320 g of artificial fine sand are added into the aging mixture for dry powder mixing to obtain dry powder mortar material.

### Comparative Embodiment 4

It is the same as Embodiment 1, and the only difference is that in step S2, 450 g of the aging mixture obtained in the step S1 is taken, and 150 g of phosphogypsum, 50 g of high alumina cement, 30 g of rubber powder and 320 g of artificial fine sand are added into the aging mixture for dry powder mixing to obtain dry powder mortar material.

### Comparative Embodiment 5

It is the same as Embodiment 1, and the only difference is that the addition of waste carbon fiber in step S3 is omitted, specifically:

S3. 400 ml of water, 15 g of amino alcohol shrinkage reducing agent and 12 g of polycarboxylic acid high-performance water reducing agent are added to the prepared dry powder mortar material (1 kg). The mixture is stirred at a speed of 300 r/min. The mixed mortar is poured into the mold, and the material is compacted by manual tamping and shaking table vibration, and the high-toughness magnesium-calcium binder mortar material from multi-component high-salinity solid waste may be obtained by curing to the corresponding age.

In order to more clearly reflect the differences in raw material consumption between the embodiments and the comparative embodiments of the disclosure, the distribution ratio of each group in Embodiments 1 to 15 and Comparative Embodiments 1 to 5 of the disclosure is shown in Tables 1 to 3.

TABLE 1
Distribution ratio of each group in the step S1 in Embodiments
1 to 15 and Comparative Embodiments 1 to 5

| | Step S1 | | | |
|---|---|---|---|---|
| | | | Aluminum dihydrogen | |
| | | | phosphate and | |
| Mortar | MSWI | | phosphogypsum | Adjust- |
| specimen | fly ash | Magnesite | leaching solution | ment |
| number | g | g | ml | of pH |
| Embodiment 1 | 700 | 300 | 1000 | 2.5 |
| Embodiment 2 | 700 | 300 | 800 | 2.5 |
| Embodiment 3 | 500 | 500 | 1000 | 2.5 |
| Embodiment 4 | 700 | 300 | 1000 | 2 |
| Embodiment 5 | 700 | 300 | 1000 | 2.5 |
| Embodiment 6 | 700 | 300 | 1000 | 2.5 |
| Embodiment 7 | 700 | 300 | 1000 | 2.5 |
| Embodiment 8 | 700 | 300 | 1000 | 2.5 |
| Embodiment 9 | 700 | 300 | 1000 | 2.5 |
| Embodiment 10 | 700 | 300 | 1000 | 2.5 |
| Embodiment 11 | 700 | 300 | 1000 | 2 |
| Embodiment 12 | 700 | 300 | 1000 | 2 |
| Embodiment 13 | 700 | 300 | 1000 | 2 |
| Embodiment 14 | 700 | 300 | 1000 | 2 |
| Embodiment 15 | 700 | 300 | 1000 | 2.5 |
| Comparative | 1000 | 0 | 1000 | 2.5 |
| Embodiment 1 | | | | |
| Comparative | 700 | 300 | 1000 (Deionized | — |
| Embodiment 2 | | | water) | |
| Comparative | 700 | 300 | 1000 | 2.5 |
| Embodiment 3 | | | | |
| Comparative | 700 | 300 | 1000 | 2.5 |
| Embodiment 4 | | | | |
| Comparative | 700 | 300 | 1000 | 2.5 |
| Embodiment 5 | | | | |

TABLE 2
Distribution ratio of each group in step S2 in Embodiments
1 to 15 and Comparative Embodiments 1 to 5

| | Step S2 | | | | | |
|---|---|---|---|---|---|---|
| | | | Light | | | |
| | | Industrial | burned | High | | |
| Mortar | Aging | solid waste | magnesium | alumina | Rubber | Artificial |
| specimen | mixture | gypsum | oxide | cement | powder | fine sand |
| number | g | g | g | g | g | g |
| Embodiment 1 | 400 | 150 | 50 | 50 | 30 | 320 |
| Embodiment 2 | 400 | 150 | 50 | 50 | 30 | 320 |
| Embodiment 3 | 400 | 150 | 50 | 50 | 30 | 320 |
| Embodiment 4 | 400 | 150 | 50 | 50 | 30 | 320 |
| Embodiment 5 | 400 | 150 (Flue gas | 50 | 50 | 30 | 320 |
| | | desulfurization | | | | |
| | | gypsum) | | | | |
| Embodiment 6 | 400 | 150 | 50 | 50 | 30 | 320 |
| Embodiment 7 | 400 | 150 | 50 | 50 | 30 | 320 |
| Embodiment 8 | 300 | 100 | 80 | 50 | 80 | 390 |
| Embodiment 9 | 350 | 120 | 80 | 20 | 30 | 400 |
| Embodiment 10 | 290 | 150 | 80 | 50 | 30 | 400 |
| Embodiment 11 | 350 | 100 | 50 | 50 | 50 | 400 |
| Embodiment 12 | 370 | 120 | 80 | 50 | 80 | 300 |
| Embodiment 13 | 350 | 150 | 50 | 20 | 30 | 400 |
| Embodiment 14 | 370 | 100 | 80 | 20 | 80 | 350 |
| Embodiment 15 | 400 | 150 | 50 | 20 | 30 | 350 |
| Comparative | 400 | 150 | 50 | 50 | 30 | 320 |
| Embodiment 1 | | | | | | |
| Comparative | 400 | 150 | 50 | 50 | 30 | 320 |
| Embodiment 2 | | | | | | |
| Comparative | 550 | 0 | 50 | 50 | 30 | 320 |
| Embodiment 3 | | | | | | |
| Comparative | 450 | 150 | 0 | 50 | 30 | 320 |
| Embodiment 4 | | | | | | |
| Comparative | 400 | 150 | 50 | 50 | 30 | 320 |
| Embodiment 5 | | | | | | |

TABLE 3
Distribution ratio of each group in step S3 in Embodiments
1 to 15 and Comparative Embodiments 1 to 5

| | Step S3 | | | |
|---|---|---|---|---|
| | | Shrinkage | Water | |
| Mortar | | reducing | reducing | |
| specimen | Fiber | agent | agent | Water |
| number | g | g | g | mL |
| Embodiment 1 | 20 | 15 | 12 | 400 |
| Embodiment 2 | 20 | 15 | 12 | 400 |
| Embodiment 3 | 20 | 15 | 12 | 400 |
| Embodiment 4 | 20 | 15 | 12 | 400 |
| Embodiment 5 | 20 | 15 | 12 | 400 |
| Embodiment 6 | 20 (Polyvinyl | 15 | 12 | 400 |
| | alcohol | | | |
| | (PVA) fiber) | | | |
| Embodiment 7 | 20 | 15 | 12 | 500 |
| Embodiment 8 | 10 | 15 | 4 | 400 |
| Embodiment 9 | 20 | 5 | 12 | 400 |
| Embodiment 10 | 10 | 15 | 4 | 400 |
| Embodiment 11 | 20 | 5 | 4 | 400 |
| Embodiment 12 | 10 | 5 | 12 | 400 |
| Embodiment 13 | 10 | 15 | 12 | 400 |
| Embodiment 14 | 20 | 15 | 4 | 400 |
| Embodiment 15 | 10 | 5 | 4 | 400 |
| Comparative | 20 | 15 | 12 | 400 |
| Embodiment 1 | | | | |
| Comparative | 20 | 15 | 12 | 400 |
| Embodiment 2 | | | | |
| Comparative | 20 | 15 | 12 | 400 |
| Embodiment 3 | | | | |
| Comparative | 20 | 15 | 12 | 400 |
| Embodiment 4 | | | | |
| Comparative | 0 | 15 | 12 | 400 |
| Embodiment 5 | | | | |

### Performance Test

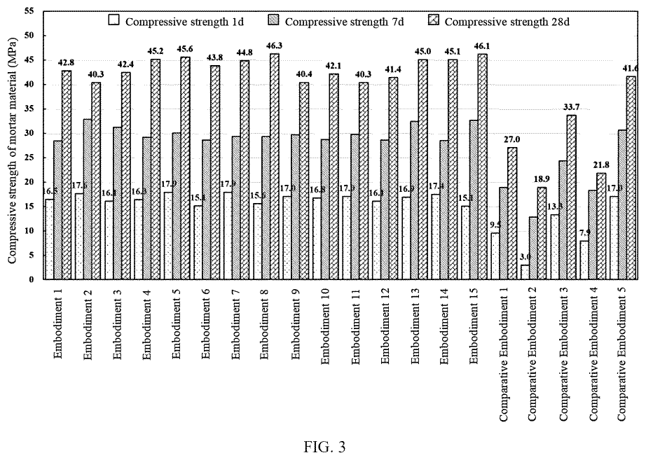

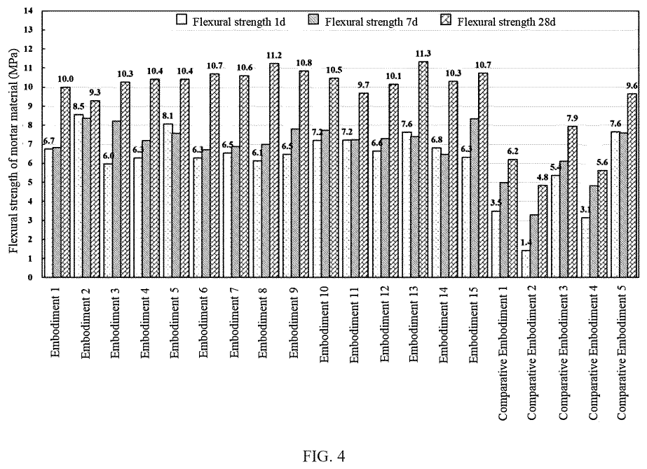

Mortar materials prepared in Embodiments 1-15 and Comparative Embodiments 1-5 are tested according to the relevant provisions in JC/T 2381-2016 Repair Mortar. The test results of compressive strength and flexural strength of mortar specimens are shown in FIG. 3 and FIG. 4 respectively. The high-toughness magnesium-calcium binder mortar materials prepared in Embodiments 1-15 of the present disclosure have higher strength characteristics. As may be seen from FIG. 3, under the standard curing conditions, the 1-d compressive strength may reach 15.1-17.9 megapascals (MPa) and the 28-d compressive strength may reach 40.3-46.3 MPa. As may be seen from the results in FIG. 4, the 1-d flexural strength may reach 6.0-8.5 MPa and the 28-d flexural strength may reach 9.3-11.3 MPa.

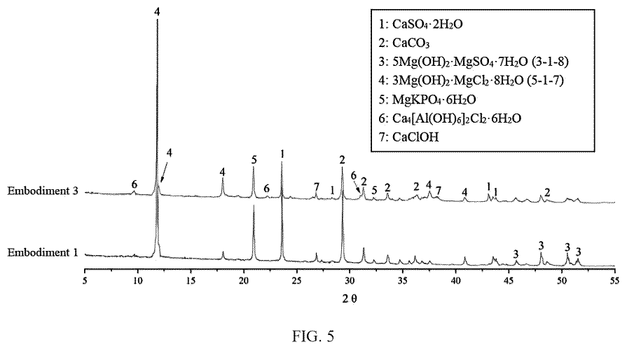

The X-ray diffraction patterns of Embodiment 1 and Embodiment 3 are shown in FIG. 5. From the X-ray diffraction patterns of Embodiment 1 and Embodiment 3 in FIG. 5, it may be known that the mortar materials produced through steps S1 to S3 all produce target mineral phases, including magnesium-calcium binder gelled products such as: magnesium potassium phosphate MgKPO₄·6H₂O, magnesium oxysulfide 5Mg(OH)₂·MgSO₄·7H₂O, magnesium oxychloride 3Mg(OH)₂·MgCl₂·8H₂O and calcium chloroaluminate hydrate Ca₄[Al(OH)₆]₂Cl₂·6H₂O. From the diffraction peak intensity, it may be seen that there are differences in the content of each product. The production of calcium carbonate also proves the reaction in step 1.

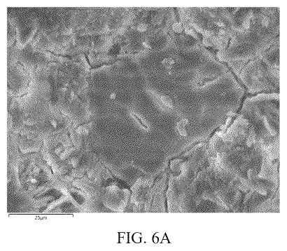

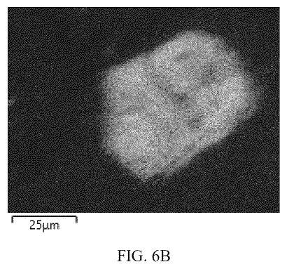

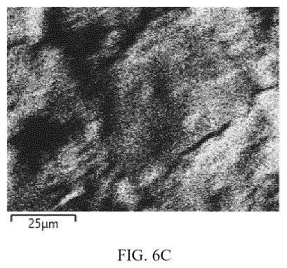

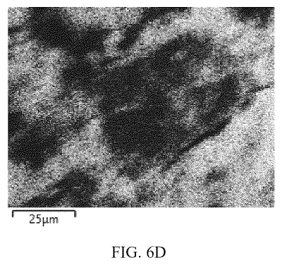

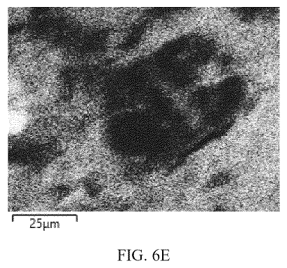

FIG. 6A, FIG. 6B, FIG. 6C, FIG. 6D and FIG. 6E are scanning electron microscope (SEM) images of the aging products after step S1 in Embodiment 1. Among them, FIG. 6A is the microscopic morphology of the aging product after step S1 in Embodiment 1, which is magnified by 10000 times. FIG. 6B is the area distribution pattern of element Ca analyzed by energy dispersive spectroscopy (EDS) of the SEM pattern. FIG. 6C is the area distribution pattern of element C analyzed by EDS of the SEM pattern. FIG. 6D is the area distribution pattern of element Mg analyzed by EDS of the SEM pattern. FIG. 6E is the area distribution pattern of element Cl analyzed by EDS of the SEM pattern. From FIG. 6A, FIG. 6B, FIG. 6C, FIG. 6D and FIG. 6E, it may also be seen that calcium carbonate precipitation and substances whose main elements are Mg and Cl are produced in the aging product of step S1 in Embodiment 1, which may be inferred as MgCl₂, which also proves the occurrence of the reaction in step S1.

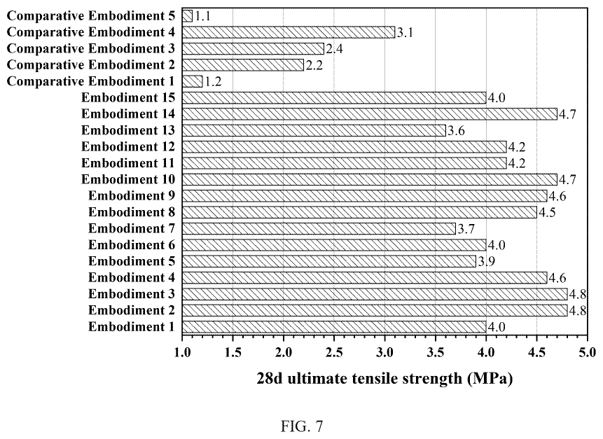

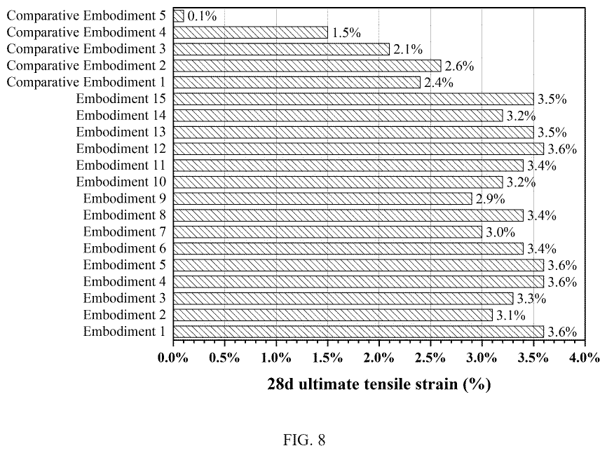

Mortar materials prepared in Embodiments 1-15 and Comparative Embodiments 1-5 are tested according to the relevant provisions in JC/T 2461-2018 Test Method for Mechanical Properties of High Ductile Fiber Reinforced Cement-based Composites. The results of ultimate tensile strength and ultimate tensile strain of mortar specimens are shown in FIG. 7 and FIG. 8. It may be seen that the high-toughness magnesium-calcium binder mortar materials prepared in Embodiments 1-15 of the present disclosure all have certain tensile strength. According to the results of FIG. 7, the ultimate tensile strength at 28 d is 3.6-4.8 MPa, and according to the results of FIG. 8, the ultimate tensile strain at 28 d is 2.9%-3.6%.

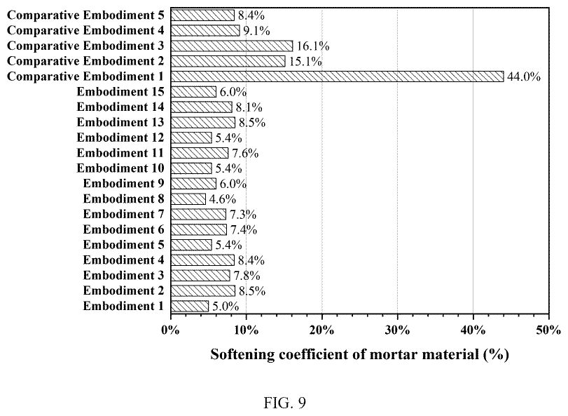

After the mortar specimen cured for 28 d is soaked in running water (1 liter per minute (L/min)) for 28 d, the surface moisture of the specimen is dried, and the compressive strength R28′ of the specimen in wet state is immediately tested. The ratio of compressive strength loss of 28 d specimen soaked in water to compressive strength R28 of 28 d specimen under standard curing conditions is the softening coefficient of mortar specimen K=(R28-R28′)/R28. The smaller the K value, the better the water resistance of the specimen. The water resistance results of the high-toughness magnesium-calcium binder mortar materials prepared in Embodiments 1-15 and Comparative Embodiments 1-5 of the present disclosure are shown in FIG. 9.

As may be seen from FIG. 9, the high-toughness magnesium-calcium binder mortar materials prepared in Embodiments 1 to 15 of the present disclosure have the characteristics of good water resistance. After soaking in water for 28 d, the softening coefficient of the specimen is between 4.6% and 8.5%. In Comparative Embodiment 1 and Comparative Embodiment 2, because the aging step fails to produce effective magnesium chloride, the mortar strength is low and the water penetration resistance is poor. In Comparative Embodiment 3, due to the lack of sulfate in step S2, the hydration product of magnesium oxysulfide in the final product is not enough, and the water resistance is significantly reduced. In Comparative Embodiment 4, due to the lack of light burned magnesium oxide in step S2, the final magnesium-calcium binder hydration products are not enough, resulting in a slight decrease in water resistance. In Comparative Embodiment 5, no fiber is added in step S3, which leads to a significant decrease in the toughness of mortar materials, but does not affect the formation of magnesium-calcium binder gelled products, so the compressive strength and water resistance are higher, and the ultimate tensile strength decreases significantly.

The leaching concentrations of heavy metals Pb, Cu, Zn, Cr and As in the original MSWI fly ash and mortar specimens are tested according to the relevant provisions in GB/T 30810-2014 Determination Method of Leachable Heavy Metals in Cement Mortar, and the results are shown in Table 4.

TABLE 4
Leaching concentrations of heavy metals
(milligrams per liter (mg/L))

| Number | Pb | Cu | Zn | Cr | As |
|---|---|---|---|---|---|
| Embodiment 1 | 0.048 | 0.426 | 0.277 | 0.170 | 0.042 |
| Embodiment 2 | 0.023 | 0.570 | 0.290 | 0.165 | 0.045 |
| Embodiment 3 | 0.055 | 0.391 | 0.205 | 0.089 | 0.038 |
| Embodiment 4 | 0.045 | 0.402 | 0.110 | 0.080 | 0.021 |
| Embodiment 5 | 0.054 | 0.434 | 0.208 | 0.095 | 0.039 |
| Embodiment 6 | 0.041 | 0.430 | 0.232 | 0.102 | 0.040 |
| Embodiment 7 | 0.038 | 0.320 | 0.190 | 0.082 | 0.040 |
| Embodiment 8 | 0.070 | 0.416 | 0.227 | 0.105 | 0.041 |
| Embodiment 9 | 0.034 | 0.440 | 0.247 | 0.109 | 0.044 |
| Embodiment 10 | 0.031 | 0.507 | 0.261 | 0.110 | 0.046 |
| Embodiment 11 | 0.047 | 0.490 | 0.252 | 0.109 | 0.043 |
| Embodiment 12 | 0.029 | 0.459 | 0.258 | 0.117 | 0.043 |
| Embodiment 13 | 0.055 | 0.475 | 0.246 | 0.107 | 0.041 |
| Embodiment 14 | 0.023 | 0.425 | 0.244 | 0.112 | 0.041 |
| Embodiment 15 | 0.042 | 0.442 | 0.232 | 0.111 | 0.040 |
| Comparative Embodiment 1 | 0.56 | 2.88 | 1.32 | 29.23 | 0.44 |
| Comparative Embodiment 2 | 0.45 | 3.41 | 1.54 | 25.52 | 0.50 |
| Comparative Embodiment 3 | 0.24 | 0.88 | 0.48 | 16.88 | 0.80 |
| Comparative Embodiment 4 | 0.52 | 2.41 | 1.38 | 31.21 | 0.85 |
| Comparative Embodiment 5 | 0.044 | 0.435 | 0.236 | 0.163 | 0.043 |
| Original MSWI fly ash | 1.49 | 5.19 | 161.2 | 44.37 | 0.87 |
| GB 5085.3-2007 limit | 5 | 100 | 100 | 15 | 5 |
| GB30760-2024 limit | 0.3 | 1 | 1 | 0.2 | 0.1 |

As may be seen from the data in Table 4, the leaching concentrations of heavy metals in the mortar materials of Embodiments 1-15 and Comparative Embodiment 5 of the present disclosure all meet the requirements of the content limit of leachable heavy metals in cement clinker in GB/T 30760-2024 Technical Specification for Co-disposal of Solid Waste in Cement Kilns and the pollution concentration limit in GB 5085.3-2007 Identification Standard for Hazardous Wastes-Identification of Leaching Toxicity. The leaching concentrations of heavy metals Pb, Cu, Zn, Cr and As in Comparative Embodiment 1, Comparative Embodiment 2 and Comparative Embodiment 4 all exceed the requirements of the limit of leachable heavy metals in cement clinker in GB/T 30760-2024 Technical Specification for Co-disposal of Solid Waste in Cement Kilns. Comparative Embodiment 1 fails to generate effective soluble magnesium salts from the MSWI fly ash itself due to the absence of magnesite addition in step S1, consequently preventing the formation of sufficient magnesium-calcium binder gelled products and demonstrating no significant solidification effect on heavy metals. Comparative Embodiment 2 fails to produce effective soluble magnesium salts through the reaction between MSWI fly ash and magnesite under alkaline conditions due to the addition of deionized water in step S1, consequently resulting in insufficient formation of magnesium-calcium binder gelled products and demonstrating no significant solidification effect on heavy metals. Comparative Embodiment 3 exhibits reduced mechanical properties in the mortar material and decreased heavy metal stabilization efficiency, with leaching concentrations of Cr and As exceeding regulatory limits, due to the absence of industrial solid waste gypsum addition in step S2 which results in an insufficient proportion of hydration products within the microstructure. Comparative Embodiment 4 demonstrates negligible heavy metal solidification effects due to the absence of light burned magnesium oxide addition in step S2, which fails to continuously supply polyhydroxy magnesium ions and consequently prevents the formation of sufficient magnesium-calcium binder gelled products for effective heavy metal stabilization. In Comparative Embodiment 5, the ultimate tensile strength and other mechanical properties of the final mortar material are insufficient because no fiber is added in step S3. However, due to the same gelling components as in Embodiment 1, enough magnesium-calcium binder gelled products are produced to stabilize heavy metals, and the solidification effect of heavy metals is good.

To sum up, the high-toughness magnesium-calcium binder mortar material from multi-component high-salinity solid waste prepared by the disclosure has the characteristics of high strength, good toughness, good heavy metal stability and the like, and may be used in the fields of municipal administration, transportation and the like.

The above are only the optional embodiments of this disclosure, but the protection scope of this disclosure is not limited to this. Any change or replacement that may be easily thought of by a person familiar with this technical field within the technical scope disclosed in this disclosure should be included in the protection scope of this disclosure. Therefore, the protection scope of this disclosure should be based on the protection scope of the claims.

What is claimed is:

1. A high-toughness magnesium-calcium binder mortar material from multi-component high-salinity solid waste, wherein raw materials comprise a dry powder mortar material, a shrinkage reducing agent, a water reducing agent and fibers, wherein an addition amount of the fibers is 1.0-2.0% of a mass of the dry powder mortar material;
wherein in parts by weight, the dry powder mortar material comprises: 28-40 parts of aging mixture, 10-15 parts of industrial solid waste gypsum, 5-8 parts of light burned magnesium oxide, 2-5 parts of high alumina cement, 3-8 parts of rubber powder and 30-40 parts of artificial fine sand; and
wherein in parts by weight, the aging mixture comprises 50-70 parts of municipal solid waste incineration (MSWI) fly ash and 30-50 parts of magnesite, as well as aluminum dihydrogen phosphate solution and phosphogypsum leachate.

2. The high-toughness magnesium-calcium binder mortar material from the multi-component high-salinity solid waste according to claim 1, wherein the MSWI fly ash is grate furnace MSWI fly ash with a potassium content ≥4 wt % and a silicon content ≤3 wt %.

3. The high-toughness magnesium-calcium binder mortar material from the multi-component high-salinity solid waste according to claim 1, wherein a total addition amount of the aluminum dihydrogen phosphate solution and the phosphogypsum leachate is 80-100% of a total mass of the MSWI fly ash and the magnesite.

4. The high-toughness magnesium-calcium binder mortar material from the multi-component high-salinity solid waste according to claim 1, wherein the water reducing agent is a polycarboxylic acid high-performance water reducing agent, an addition amount of the water reducing agent is 0.4-1.2% of the mass of the dry powder mortar material, the shrinkage reducing agent is an amino alcohol shrinkage reducing agent, an addition amount of the shrinkage reducing agent is 0.5-1.5% of the mass of the dry powder mortar material, and the fibers are one or more of polyethylene fibers, polyvinyl alcohol fibers or waste carbon fibers.

5. The high-toughness magnesium-calcium binder mortar material from the multi-component high-salinity solid waste according to claim 1, wherein a specific surface area of the industrial solid waste gypsum is not less than 500 square meters per kilogram (m²/kg);
the light burned magnesium oxide is obtained by calcining the magnesite at 950-1050 degrees Celsius (° C.), and a MgO content is not less than 90%; and
a specific surface area of the high alumina cement is not less than 300 m²/kg.

6. The high-toughness magnesium-calcium binder mortar material from the multi-component high-salinity solid waste according to claim 1, wherein the rubber powder is vulcanized rubber powder, and a maximum particle size of the artificial fine sand does not exceed 325 micrometers (μm).

7. A preparation method of the high-toughness magnesium-calcium binder mortar material from the multi-component high-salinity solid waste according to claim 1, comprising following steps:
mixing the MSWI fly ash and the magnesite, ball milling to obtain a solid waste mixture, mixing the aluminum dihydrogen phosphate solution and the phosphogypsum leachate to prepare a mixed solution, adding the mixed solution into the solid waste mixture, uniformly mixing, aging, drying, finely grinding and sieving to obtain the aging mixture;
adding the industrial solid waste gypsum, the light burned magnesium oxide, the high alumina cement, the rubber powder and the artificial fine sand into the aging mixture for dry powder mixing to obtain the dry powder mortar material; and
adding water, the shrinkage reducing agent and the water reducing agent into the dry powder mortar material, uniformly stirring, adding the fibers, continuously stirring, pouring mixed mortar material into a mold, and carrying out compact molding to obtain the high-toughness magnesium-calcium binder mortar material from the multi-component high-salinity solid waste.

8. The preparation method of the high-toughness magnesium-calcium binder mortar material from the multi-component high-salinity solid waste according to claim 7, wherein the aluminum dihydrogen phosphate, the phosphogypsum leachate and the water are mixed, and pH is adjusted to 2.0-2.5 with phosphoric acid to obtain the mixed solution.

9. The preparation method of the high-toughness magnesium-calcium binder mortar material from the multi-component high-salinity solid waste according to claim 7, wherein a mixing time of the dry powder mixing is 30 seconds(s) and a rotating speed is 150 revolutions per minute (r/min).

10. The preparation method of the high-toughness magnesium-calcium binder mortar material from the multi-component high-salinity solid waste according to claim 7, wherein the fibers are added in twice, and a mass ratio of the fibers added twice is 1:1.
